(19) United States
(12) Patent Application Publication
(10) Pub. No.: US 2026/0056824 A1
(43) Pub. Date: Feb. 26, 2026

(54) AI-ASSISTED IT MANAGEMENT

(71) Applicant: SOLUTIONS iT, The Dalles, OR (US)

(72) Inventors: Derrick Thomas, The Dalles, OR (US); Jacob Dunaway, The Dalles, OR (US); Joseph Changar, The Dalles, OR (US)

(21) Appl. No.: 18/814,139

(22) Filed: Aug. 23, 2024

(51) Int. Cl. G06F 11/07; G06F 21/56

(52) U.S. Cl. CPC G06F 11/0784; G06F 11/0769; G06F 11/0793; G06F 21/56

(57) ABSTRACT

Embodiments herein may relate to a process to be performed by an electronic device. The process may include identifying an error condition related to a first computing device of a plurality of computing devices. The process may further include generating, based on a machine learning (ML) model, an indication of the error condition that is provided to a user, wherein the indication includes: a non-technical summary of the condition; and a recommended action to remedy the error condition. Other embodiments may be described and/or claimed.

### BACKGROUND

Various organizations may have a network of computers that are linked together for the sharing of, and to include, common resources such as hardware resources (servers, printers, etc.) or software resources (folders or files). Additionally the use of such a network may provide additional advantages such as shared security or shared administration. To such an end, it may be common for a network to be managed by information technology (IT) professionals as such management may require the ability to process and respond to highly technological information in various scenarios.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a user interface, in accordance with various embodiments.

FIG. 2 illustrates an alternative example of the user interface of FIG. 1, in accordance with various embodiments.

FIG. 3 illustrates an alternative example of the user interface of FIG. 1, in accordance with various embodiments.

FIG. 4 illustrates an alternative example of the user interface of FIG. 1, in accordance with various embodiments.

FIG. 5 illustrates an alternative example of the user interface of FIG. 1, in accordance with various embodiments.

FIG. 6 illustrates an alternative example of a user interface, in accordance with various embodiments.

FIG. 7 illustrates an alternative example of a user interface, in accordance with various embodiments.

FIG. 8 illustrates an alternative example of a user interface, in accordance with various embodiments.

FIG. 9 illustrates an example process related to AI-assisted IT management, in accordance with various embodiments.

FIG. 10 illustrates an example computing system suitable for practicing various aspects of the disclosure, in accordance with various embodiments.

FIG. 11 illustrates an example non-transitory computer-readable storage medium having instructions configured to practice all or selected ones of the operations associated with the processes described in reference to FIGS. 9 and 10.

### DETAILED DESCRIPTION

As previously noted, various organizations may have a network of computers that are linked together for the sharing of, and to include, common resources, to provide security, and/or to administer various elements of the network such as the hardware resources and/or computers. To such an end, it may be common for a network to be managed by IT professionals as such management may require the ability to process and respond to highly technological information in various scenarios.

However, such administration by an IT professional may have some drawbacks. For example, the IT professional may represent an additional overhead expense to the organization. Additionally, if there is an issue with a computer and an IT professional is unavailable, it may be difficult for the user of that computer to perform their allocated work assignment. As such, work may be delayed and/or bottlenecks in the workflow of the organization may be created.

Embodiments herein relate to an artificial intelligence (AI)-assisted system for managing computers. Specifically, embodiments may relate to or describe a client-facing tool that allows a user to manage their own computer by presenting information in a user-parseable manner. The portal may also allow the user to perform tasks such as adding or removing software from their computer, adding or removing services from their computer, tracking the tasks (or “jobs”) being performed by their computer, etc. In addition, the system may allow for an administrator to perform similar tasks or management without the aid of an IT professional.

As used herein, the term “user” may be used to refer to an individual that has permission to access one or more resources of the network. Such users may include single-computer users and administrators.

The term “single-computer user” may refer to an individual user that is only enabled to interact with or perform tasks for a single computer. Such a user may have limitations to the types of interactions or tasks that they can do. For example, such a user may not be able to create groups on the network, add or remove computers to the network, etc.

An “administrator” may be capable of interacting with or performing tasks related to a plurality of computers. Generally, an administrator may have a greater amount of privileges or access than a single-computer user. For example, an administrator may be able to create email groups, computer groups, add or remove a computer to the network, etc.

As used herein, the term “computer” and “machine” may be used interchangeably. Such terms may apply to electronic devices such as laptops, desktops, personal digital assistants, tablets, cellular telephones, etc. In some embodiments, such terms may additionally or alternatively apply to virtual machines that are activated as part of the network. Additionally, in some embodiments such terms may, unless indicated otherwise, apply to other hardware, software, firmware, and/or virtual elements of the network such as printers, routers, modems, etc. that may be communicatively coupled with other electronic devices of the network. More generally, it will be recognized that the description herein is presented at a relatively high level for the sake of discussion only, and real-world implementations may have one or more additional and/or alternative elements.

It will be understood that this description is intended as a highly simplified example of different roles within the network, and in real world implementations there may be additional or alternative roles for individuals that are related to the network. Examples of such roles could be or include an office-wide administrator as opposed to an organization-wide administrator, a hardware/peripheral administrator, etc.

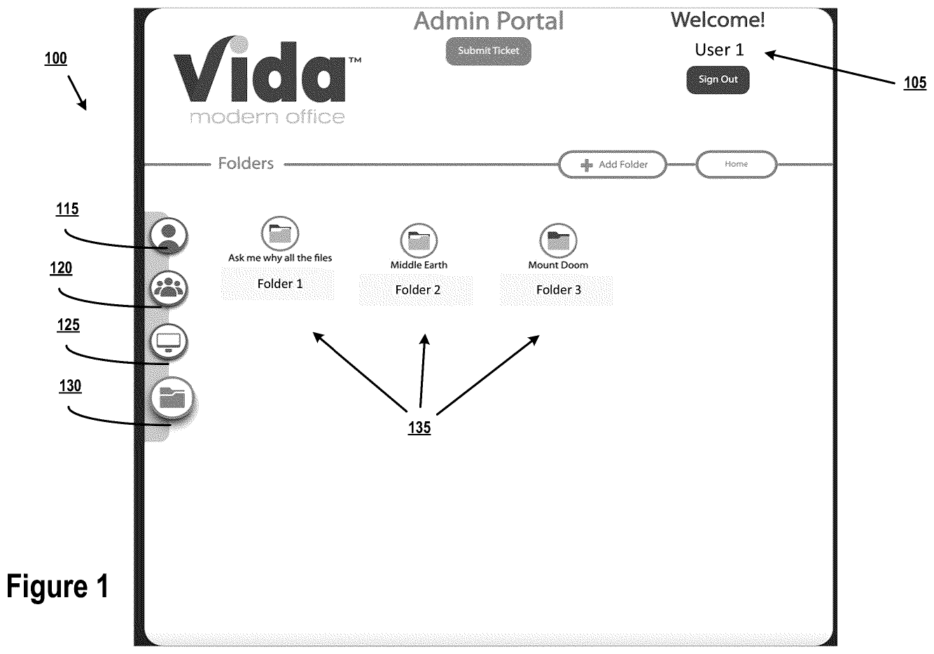

FIGS. 1-8 depict various examples of a user interface by which an individual may interact with a computer, in accordance with various embodiments. In some embodiments, the user interface may be referred to as a “graphical user interface” (GUI). However, it will be understood that information of the user interface may be presented to a user in a different manner, for example via haptic feedback, audio, etc.

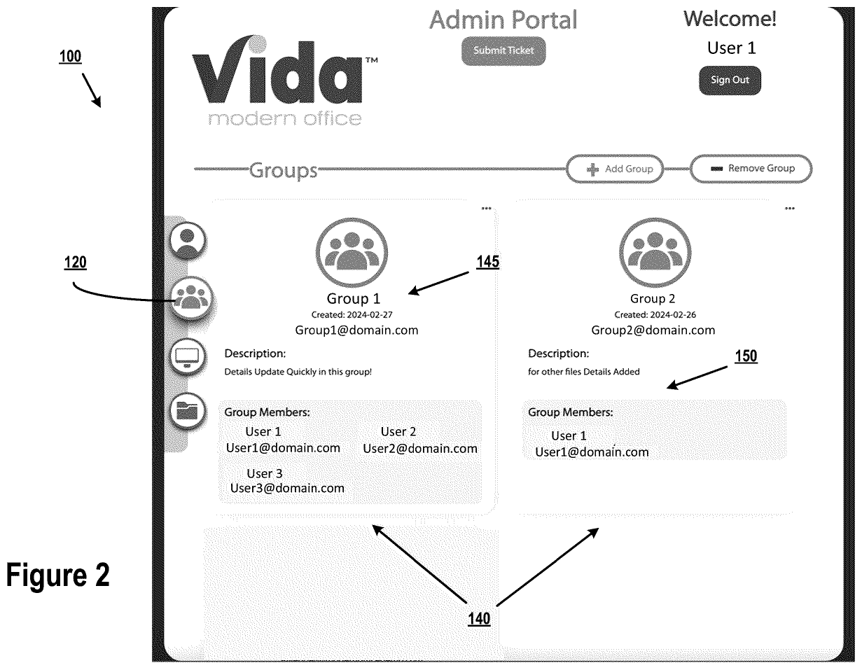

Generally, the various elements described herein may be described with respect to performance of actions by an administrator. However, in other embodiments, a single-computer user may be enabled to perform one or more of the described actions. It will also be understood that the depicted user interfaces are intended as simplified examples of such interfaces in accordance with specific embodiments of the present disclosure. The specific words and/or logos used, the shape and/or placement of various elements, etc. may be different in other embodiments and/or implementations. Rather, the examples herein are provided for the sake of non-limiting discussion unless otherwise indicated. Additionally, it will be understood that various elements may be seen and described with respect to one of the Figures (e.g., FIG. 1), but may not be specifically re-enumerated or re-described with respect to other Figures such as FIG. 2 and/or some other Figure. However, elements that persist between Figures may generally be presumed to be the same element unless explicitly indicated otherwise.

FIG. 1 depicts an example of a user interface 100. The depicted user interface 100 may be an interface to be used by an individual in an administrator role. In some embodiments, the user interface 100 may include an indication of a name of the individual (e.g., the administrator) as seen at 105. It will be understood that the term “user interface” is used herein in its generalized sense to refer to an interface that is used by an individual that is interacting with the electronic device on which the interface is presented. For the sake of description herein, such individual will be described as an administrator to refer to an individual acting in an administrative role as previously described. Such individual, unless indicated to the contrary, is not intended to be a single-computer user for the sake of this discussion. However, it will further be understood that such individual may, in some cases and depending on the limited permissions and functions granted that individual, be a single-computer user.

The administrator may be able to select between a variety of tabs, which may lead to different “pages” or “tabs.” The respective pages or tabs may display one or more alternative options or alternative types of information to the administrator. For example, the different pages or tabs may be different hypertext transfer protocol (HTTP) pages or some other different type of page.

The tabs depicted with respect to FIG. 1 include a user tab 115, a groups tab 120, a computer tab 125, and a folders tab 130.

The user tab 115, which may also be referred to a “user management” tab, may allow the administrator to perform tasks such as creating, editing, and/or removing users from the network. Such tasks may be limited to individuals acting as administrators, as opposed to single-computer users. In some embodiments, the user tab 115 may additionally or alternatively allow an administrator to perform tasks such as setting or resetting user's passwords, setting or resetting user's multi factor authentication, etc. In some embodiments, the user tab 115 may allow an administrator to purchase, add, remove, and/or assign additional software or licenses to a user's profile. In this manner, the user's profile may allow the individual associated with that profile to have the same privileges and/or software from a variety of computers, rather than the individual being limited to the use of a single computer. For example, the user's profile and data/licenses associated with the user's profile may be stored in a centralized location such as a server, in the cloud, etc. An individual (e.g., a single-computer user) may be able to log in from various ones of a plurality of machines of the network, said machine may access the server to gain information related to the user's profile, and then configure the machine of the network in accordance with the user's profile so that the individual has access to the same files, programs, configurations, etc. as they would if they were on their “home”machine.

The group tab 120 may allow the administrator to create, remove, and/or manage groups of users. Different ones of the groups may be assigned different permissions. For example, the permissions may relate to access, by users of the group, to various hardware (e.g., servers, printers, etc.), data, files, licensed programs, etc. In some embodiments, the different groupings may have different email addresses so that a group of users may be communicated with via a single email to the group. In some embodiments, the groups may be desirable because they may allow the administrator to selectively restrict or allow permissions to individuals of the group, thereby increasing the ease and efficiency of security management.

The computer tab 125 may allow an individual to view the current state of a computer, including elements such as the health of the machine (e.g., whether the machine has an appropriate amount of random access memory (RAM), remaining data storage capacity of the machine, etc.) and alerts that the machine may have. Such alerts may relate to an error condition such as a virus, a hardware error, or some other error condition.

The individual (which may be an administrator or a single-computer user) may also be allowed to perform commands such as application installs, print spooler resets, computer restarts, computer resets, removal of the computer from the network, and/or some other action. In some embodiments, the computer tab may only present information regarding the machine which is currently being used by the individual. This may be the case if, for example, the user is a single-computer user. In some embodiments, for example if the individual is an administrator, the computer tab may present information to the administrator regrading various machines and/or hardware that is different than the machine with which the administrator is currently interacting.

The folder tab 130 may allow an individual, and particularly an administrator, to create folders related to various files. The individual may also be allowed to indicate which other user(s) is/are allowed to access the contents of the folders. In some embodiments, the individual may be allowed to indicate which groups (e.g., groups as described with respect to group tab 120) are allowed to access the contents of the folders. In some embodiments, different users, groups of users, groups of machines, etc. may be given different permissions such as read-only, copy, and/or write permissions. In some embodiments, the folders may be limited such that a user is only able to see which file(s) are in a given folder, but may otherwise be unable to interact with the contents of a folder. For example, a folder may include data that is stored on a plurality of different machines. That data may only be interacted with from one of the plurality of different machines.

In the example of FIG. 1, FIG. 1 depicts an example view of a Folder tab, showing a plurality of folders 135 (labelled, “Folder 1,” “Folder 2,” and “Folder 3.” Although not explicitly shown in FIG. 1, from this page, the individual (e.g., the administrator) may be able (for example by selecting a folder, double-clicking on a folder, right clicking on a folder, etc.) to perform various actions such as modifying the group(s) or user(s) that are able to access a folder, modify the contents of a folder, create a new folder, delete an existing folder, modify the name of an existing folder, duplicate a folder, and/or perform some other task related to a folder.

FIG. 2 depicts an example of the user interface 100 if the individual selected the group tab 120. As may be seen, two groups 140 are displayed, which are labelled as “Group 1” and “Group 2.” Respective ones of the groups 140 may include a name, along with other relevant information such as a date on which the group was created and/or an email address as may be seen at 145. For example, the name of one group may be “Group 1,” and may have an email address of “Group1@domain.com.” The name of another group may be “Group 2,” and may have an email address of “Group2@domain.com.”The user interface 100 may further depict an example of the members of each group at 150. For example, Group 1 may have users “User 1,” “User 2,” and “User 3.” By contrast Group 2 may only have user “User 1.” The respective email addresses of the users may further be displayed.

It will be understood that these depictions are intended as examples, and other information may be presented either in the group tab 120, or if an individual selects one of the groups 140. For example, information regarding the purpose of the group, different icons or contact information (e.g., phone numbers, etc.) of group members or group administrators, etc. may be present in other embodiments.

Although such functions may not explicitly be shown in FIG. 2, it will be understood that, in various embodiments, the individual may be able to alter the groups in some way. For example, an administrator may be able to add new groups, remove groups, change information regarding a group (e.g., name, email address, icon, etc.) change members of a group, change permissions or licenses associated with a group, etc. In general, the groups are intended to allow an individual, particularly an administrator, to quickly and easily manage user characteristics such as permissions, security, and/or access for a plurality of users of the network by “grouping” the users and then changing the characteristics for the group as a whole.

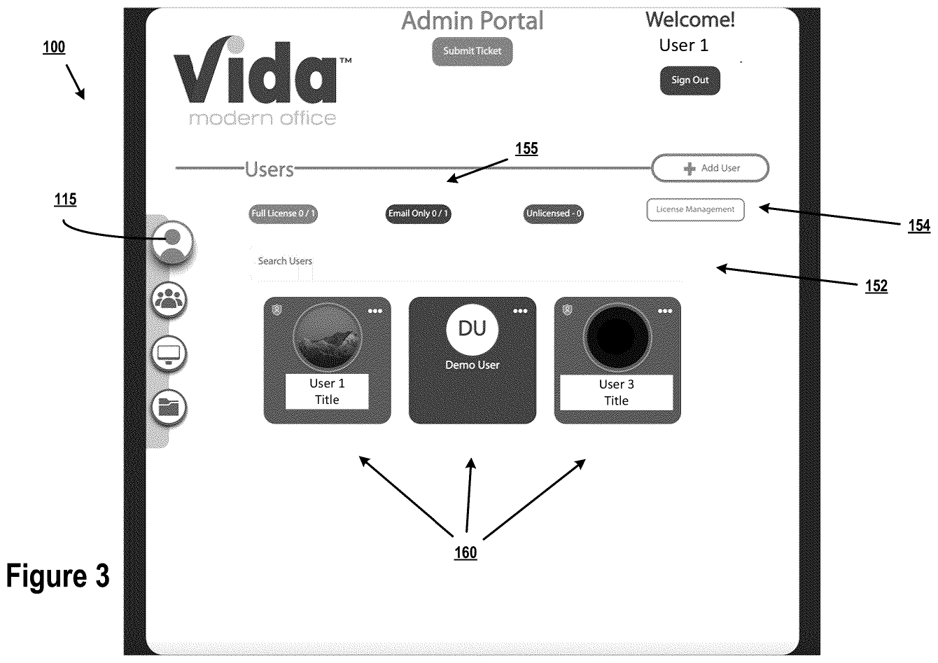

FIG. 3 depicts an example of the users tab 115. As may be seen, the administrator may be presented with information related to a plurality of users 160. The information regarding the users may include, for example, a user icon, a name of the user, a title of the user, etc. In some embodiments, selecting (e.g., clicking, double clicking, right clicking, etc.) one of the users 160 may present additional information such as a full name of the user, an address of the user, an email address of the user, a telephone number of the user, a department and/or location of the user, etc.

The user tab 115 may additionally include a search bar 152 which may allow the individual (which may be a single-computer user and/or an administrator) to search for various ones of the users. The search may be performed according to a variety of criteria such as name, job title, department, location, phone number, etc.

The user tab 115 may additionally include information 155 regarding permissions of various ones of the users. In some embodiments, the individual (e.g., an administrator and/or a single-computer user) may be able to select an element of the information 155 (e.g., the “full license” element), which may cull the list of users 160 to only users that satisfy the selected criteria.

In some embodiments, an administrator may be able to change characteristics of the users 160 and/or the user tab. For example, an individual acting in an administrator role may have the permissions to add or remove users 160, change a characteristic of a user (e.g., their name, email address, phone number, department, title, etc.).

In some embodiments, an administrator may be able to change licenses or other permissions of various ones of the users 160. For example, the administrator may be able to assign one or more of the users, via the license management element 154 or via an element in a profile of a user 160, to a license for a piece of software. In this way, the administrator may be able to quickly and easily enable different workflows for different ones of the users 160.

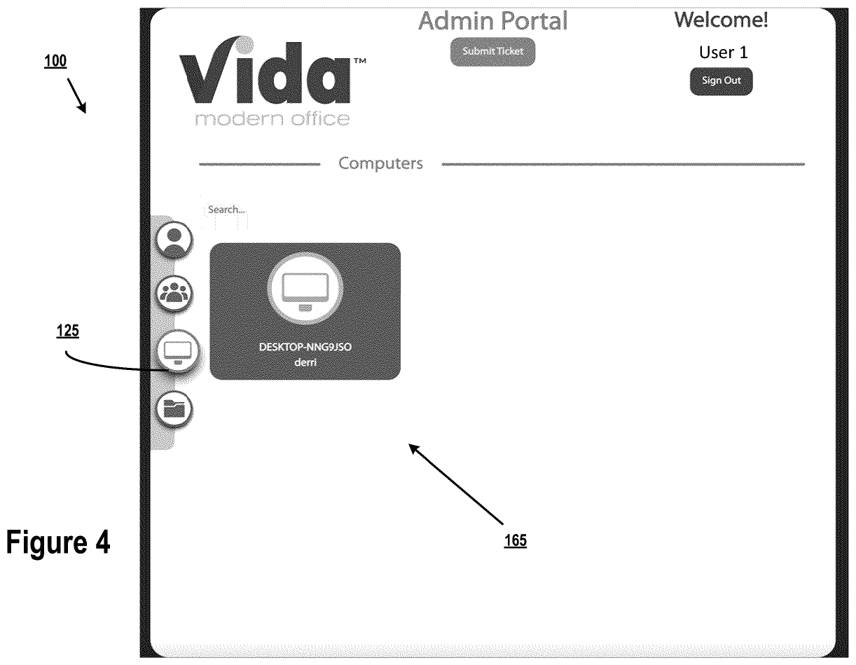

FIG. 4 depicts an example user interface 100 wherein an individual has selected the computer tab 125. Such selection may show information regarding one or more machines to which the individual has access. In the example of FIG. 4, only a single computer is shown at 165. The computer has a name of “DESKTOP-NNG9JSO,” and is currently being used by user “derri.” The view of a single computer may be presented if, for example, the individual accessing the computer tab 125 is a single-computer user and, in this case, user “derri.” Alternatively, a single computer may be presented if the individual accessing the computer tab is an administrator but only a single computer is connected to the network. In other embodiments, a plurality of computers may be presented if the individual access the computer tab 125 is an administrator. In other embodiments, one or more additional computers, virtual machines, hardware elements, etc. may be presented in the computer tab 125.

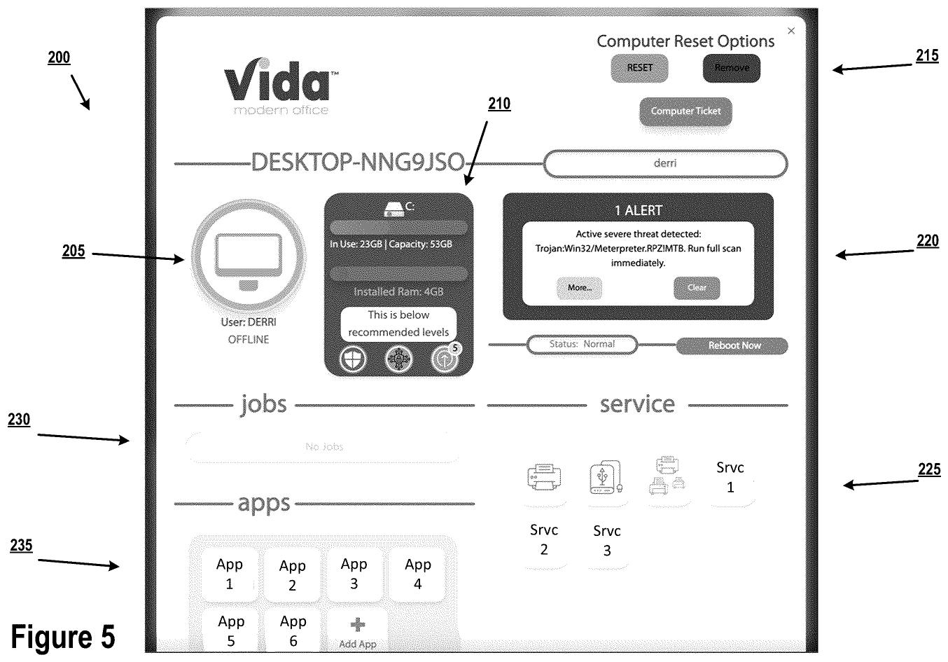

It will be understood that the machine of FIGS. 5-8 may be referred to as a “computer,” and may be indicated to be a desktop computer (e.g., based on the name of “DESKTOP-NNG9JSO”). However, in other embodiments the machine to which the user interface applies may be a laptop, a PDA, a cell phone, a tablet, a virtual machine, and/or some other machine as previously described.

In some embodiments, the individual may be able to select (e.g., click, double-click, right click, etc.) the displayed computer in the computer tab 125 and then view more information related to that computer. FIG. 5 depicts an example user interface 200 that may provide detailed information related to selection of the computer tab 125. Specifically, FIG. 5 depicts an example of detailed information related to computer “DESKTOP-NNG9JSO.”

The user interface 200 may depict, for example, a status of the computer at 205. As shown at 205, user “derri” is the last logged in user for the machine. The status of the machine at 205 is shown as “offline.” Such status may indicate, for example, that the machine is not turned on, the machine is not connected to the network, etc. In some embodiments, the offline status may indicate that the software that provides the status indication to the network is removed or is not working. Once the machine returns to an “online” condition, for example is turned on and is connected to the network, the machine's status at 205 may be “online” and the user depicted at 205 may be the most recent user that logged in to the machine.

User interface 200 may additionally include information related to jobs or tasks currently being performed by the computer at 230. Such jobs may include, for example, jobs or tasks related to printing, file backup, defragmentation, virus scan, etc.

User interface 200 may further include information related to one or more applications (or “apps”) 235 that may be installed on the computer. In some embodiments, the user, whether they are an administrator or a single-computer user, may be enabled to select one or more of the apps, and the app will be installed on their machine for their use. In other embodiments, the apps 235 may only display applications that are already installed on the computer, and additional apps may be installed, for example by an administrator. In some embodiments, the single-computer user and/or administrator may be allowed to remove one or more of the installed apps 235, for example by right-clicking on an icon and selecting an option such as “remove,” or “delete.”

It will be understood that the apps shown at 235 are depicted as abstractions for the sake of discussion. Such apps may include third party or proprietary apps such as network-chat apps, internet browsers, portable document format (PDF) readers, compression apps, and/or some other type of app. In some embodiments the name of the app, the icon of the app, and/or some other characteristic of the app may be shown at 235.

The user interface 200 may further include an indication of services 225 related to the computer. The services 225 may include or relate to management services that an administrator or single-computer user may wish to perform on a computer. Such services may include, for example, resetting a printer spooler, checking a hard drive disk of the machine, etc. In some embodiments, the services may additionally or alternatively include the ability to put service-related shortcuts on the desktop of the machine. Other such services may be included in other embodiments. The user interface 200 may further include an indication of computer health 210. The computer health 210 may depict, for example, total capacity of storage of the computer, remaining capacity of storage of the computer, an amount of memory of the computer, etc.

In some embodiments, the computer health 210 may additionally indicate a user-parseable or “plain text” summary of the health of the machine. For example, at 210 such summary is “This is below recommended levels.” In some embodiments, the summary may be based on a comparison of a computer-health element such as amount of memory against a threshold and, if the amount of memory is below the threshold, then the summary is selected and depicted from a set of pre-configured summary elements (e.g., in a table or database). In other embodiments, the summary may be generated based on an artificial intelligence (AI) engine or machine learning (ML) model. For the sake of discussion herein, a distinction is not made between an AI engine and an ML model, and such elements will be collectively referred to as “AI/ML logic.” For example, various factors such as the number of apps on the machine, the processing speed of the machine, the general usage of the machine, the amount of memory installed on the machine, etc. may be provided to the AI/ML logic. The AI/ML logic may identify whether the amount of memory is sufficient based on elements such as predicted usage, predicted maximum usage, predicted average usage, predicted memory requirements, etc. Based on the prediction, the AI/ML logic may output an indication related to sufficiency of the memory of the computer. In some embodiments, such output may itself be generated by the AI/ML logic in a simplified and plain text format as shown in FIG. 5. In this manner, an individual may be able to troubleshoot the computer's health and/or status without needing a significant amount of training or background in IT. In this example, an individual may be able to quickly and easily identify that adding more RAM to the machine may be advisable. As such, the individual may be authorized to undertake the task, or contact an IT professional to undertake the task on their behalf.

The user interface 200 may further include an alert portion 220 as shown in FIG. 2. The alert portion 220 may display, for example, one or more alerts related to the computer. In the example of FIG. 5, an alert is displayed showing that a virus named “Trojan:Win32/Meterpreter.RPZ!MTB” is present on the computer. The alert portion 220 may provide the user with an option to gain further information (e.g., as indicated by the “More” button, and as described in further detail below) and/or clear the alert. In some embodiments, clearing the alert may only be a temporary clear for a pre-identified time period, or may be a permanent clearing of an alert related to a given issue.

The user interface 200 may further include one or more resolution options at 215. The resolution options 215 may include, for example, an option to reset the computer or remove the computer, as will be described in further detail below. In some embodiments, the resolution options 215 may further include an option to escalate an issue to an IT professional. In the embodiment of FIG. 5, such option is depicted as “computer ticket” wherein a ticket can be submitted to an IT helpdesk or some other IT individual.

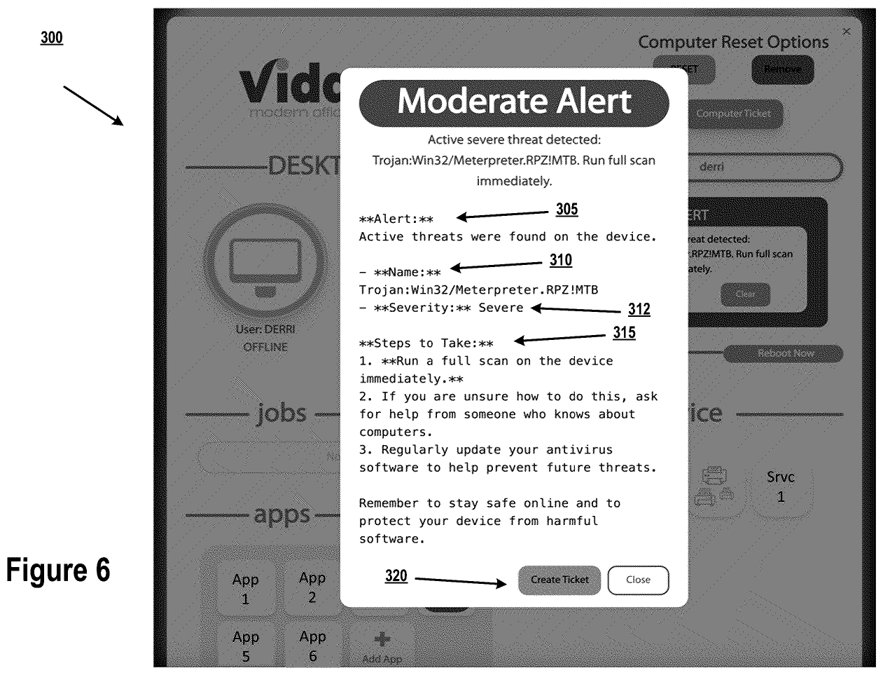

FIG. 6 depicts an example of a user interface 300 depicting additional information related to an alert. Such a window may be depicted, for example, if an individual selected the “more”option at 220.

The user interface 300 may include various elements as shown in FIG. 6. Specifically, the user interface may include a summary portion 305, a name portion 310, a severity portion 312, a recommendation portion 315, and an action portion 320.

The summary portion 305 may include a summary of the alert. For example, in the embodiment depicted in FIG. 6, the summary portion 305 depicts a summary that indicates that “active threats were found on the device.”

The name portion 310 may include a name of the error condition (e.g., the name of the virus).

The severity portion 312 may include an indication of the severity of the alert. For example, in FIG. 6, the severity of the alert is indicated as “severe.” In other embodiments, the severity may be another indication such as “moderate,” “mild,” etc. In some embodiments, the severity rating may be color coded, based on a numerical ranking, etc.

The recommendation portion 315 may include one or more recommendations for the user to take to address the alert. For example, the recommendations may include immediate recommendations such as “run a full scan on the device.” The recommendations may additionally/alternatively include recommendations for future or preventative action such as “regularly update your antivirus software to help prevent future threats.”

The action portion 320 may include a number of actions that a user may take based on the alert. For example, as shown, the action portion 320 may include a link that allows a user to create a ticket that would escalate the issue to an IT professional. The action portion 320 may additionally include a link to close the alert window depicted in FIG. 6. In some embodiments, the action portion 320 may include one or more additional or alternative elements such as a remedial action that a user may perform to remedy the issue that triggered the alert. For example, the remedial action may include a link that would allow a user to immediately perform one or more of the actions presented in the recommendation portion 315 such as running a virus scan.

In some embodiments, the network may further include storage, memory, or some other type of database that is communicatively coupled machines or computers of the network and/or the AI/ML logic. The storage may be implemented on the same machine or in the same location as one or more other elements of the network (e.g., one or more servers, one or more computers, etc.) and/or the AI/ML logic. In other embodiments, the storage may be implemented separately from, and communicatively coupled with the various elements of the network and/or the AI/ML logic. Such storage may be non-volatile memory such as flash memory, double data rate (DDR) memory, and/or some other type of memory.

In some embodiments, various of the elements presented in the user interface 300 may be based on pre-configured or pre-generated elements that are stored, for example, in the storage as described above. For example, various of the elements such as the recommendation portion 315, the summary portion 305, and/or some other portion may be pre-generated or pre-configured (e.g., by an administrator of the network). These elements may then be stored in the storage along with an identifier such as “virus,” “trojan,” and/or some other identifier. When an alert is detected on a machine, then the pre-configured element may be retrieved from storage and displayed to the user via user interface 300.

In some embodiments, various of the elements presented in the user interface 300 may be based on, or generated by, AI/ML logic. More specifically, the AI/ML logic may be configured to parse data related to the alert and generate a user-parseable output that is then presented to the user.

In the current example, the name of the virus that generated the alert, “Trojan: Win32/Meterpreter.RPZ!MTB” may be provided to the AI/ML logic. The AI/ML logic may be logic that is implemented on, in, or by the computer on which the alert is generated. In some embodiments, the AI/ML logic may be logic that is communicatively coupled with or part of the network, but separate from the computer on which the alert is generated. For example, the AI/ML logic may be logic that is implemented on or by the computer at which the administrator is interacting with the network. As another example, the AI/ML logic may be logic that is implemented remotely from the network (i.e., in “the Cloud.”). In some embodiments, the AI/ML logic may be implemented based on some combination of the above, and/or some other logic implementation.

In some embodiments the alert, or information related to the alert, may be pushed to the AI/ML logic by the administrator, by the computer at which the administrator is interacting with the network, by the computer at which the alert is occurring, or by some other element of the network. In some embodiments, the AI/ML logic, or a computer that is implementing the AI/ML logic, may actively monitor for alerts and/or error conditions, and then request/retrieve information related to the alert from the affected computer or from another element of the network.

Based on the type and/or name of the alert, the AI/ML logic may then generate one or more user-parseable elements such as those shown in FIG. 3. For example, the AI/ML logic may generate at least a portion of one or more of the summary portion 305, name portion 310, severity portion 312, recommendation portion 315, and action portion 320.

As used herein, the term “user-parseable” is intended to describe non-technical wording or instructions that are usable by an average computer user that does not have advanced IT knowledge. Such a user may be, for example, an average employee at a desk job that requires interaction with a computer for tasks such as word processing, spreadsheets, diagrams, etc. Such a user may be distinguished, for example, from an IT professional that has advanced knowledge of computers and/or operating systems (OSs) thereof, and would be capable of understanding and acting on technical data or instructions related to the alert.

As the AI/ML logic generates one or more user-parseable elements in response to an alert, the AI/ML logic may store such elements in the storage, for example in a table or some other memory structure. Such storage may include, for example, elements that include one or more fields such as the name of the error condition that triggered the alert, the time and/or date stamp of the alert, the computer at which the alert was triggered, and/or the AI/ML generated user-parseable element(s).

When the AI/ML logic identifies that an alert is generated at a computer of the network, then the AI/ML logic may search the storage prior to generating the one or more user-parseable elements. For example, the AI/ML logic may search the storage using the name of the error condition that triggered the alert. If one or more previously-generated user-parseable elements are found, then the AI/ML logic may retrieve such elements from the storage for presentation to the user rather than re-generating such elements. In some embodiments, the retrieval and display process may be faster and/or more efficient, thereby further increasing the ease of use of the network by a user without advanced IT-related training.

In some embodiments, AI/ML logic may additionally or alternatively be configured to identify the action that is presented to the user in the recommendation portion 315 and/or the resolution options 215 of FIG. 5. For example, AI/ML logic may be configured to generate, based on factors such as the name of the error condition, the type (e.g., virus, trojan, malware, ransomware, etc.) of the error condition, and/or some other factor, one or more actions that are recommended to handle and/or resolve the error condition. In some embodiments, the AI/ML logic that generates the recommended action may be the same AI/ML logic as that which generates the user-parseable language described above. In other embodiments, the AI/ML logic that generates the recommended action may be different logic than that which generates the user-parseable language described above.

In some embodiments, the AI/ML logic may be configured to identify and select from a variety of pre-identified resolution options. For example, the options presented at resolution options 215 and/or the recommendation portion 315 may include additional or alternative elements related to termination of one or more processes of the machine, rebooting the machine, deleting one or more files or folders of the machine, isolating one or more files or folders on the machine, and/or some other process or element. The AI/ML logic may be configured to identify which of the various pre-configured elements is appropriate, and then present said element to the user at, for example resolution options 215 and/or as a basis for the recommendation portion 315.

In other embodiments, the action presented to the user may be pre-configured based on the basis for the error condition/alert. For example, the storage described above, or some other storage, may include information that couples a recommendation action to an error condition or type of error condition. As such, if a type of error condition is identified by name, by error condition type, and/or by some other identifier, then the action may be pre-configured based on the association of the error condition to the action.

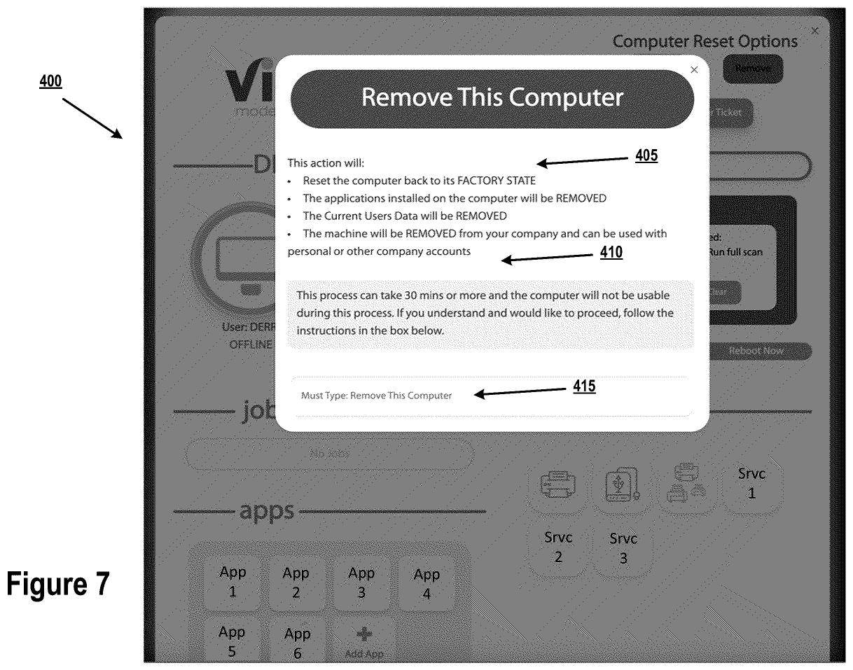

FIG. 7 depicts an alternative example of a user interface 400. Such a user interface 400 relates to removal of a computer from the network, and may be presented if an individual selected “remove”from the resolution options 215 of FIG. 5.

Similarly to user interface 300, user interface 400 may include a number of portions such as a results portion 405, a warning portion 410, and an action portion 415. The results portion 405 may present one or more indications of the result of proceeding with the action. The warning portion 410 may present the user with one or more warnings related to proceeding with the action. Finally, the action portion 415 may present the user with some action item that is to be taken by the user to proceed with and/or start the action.

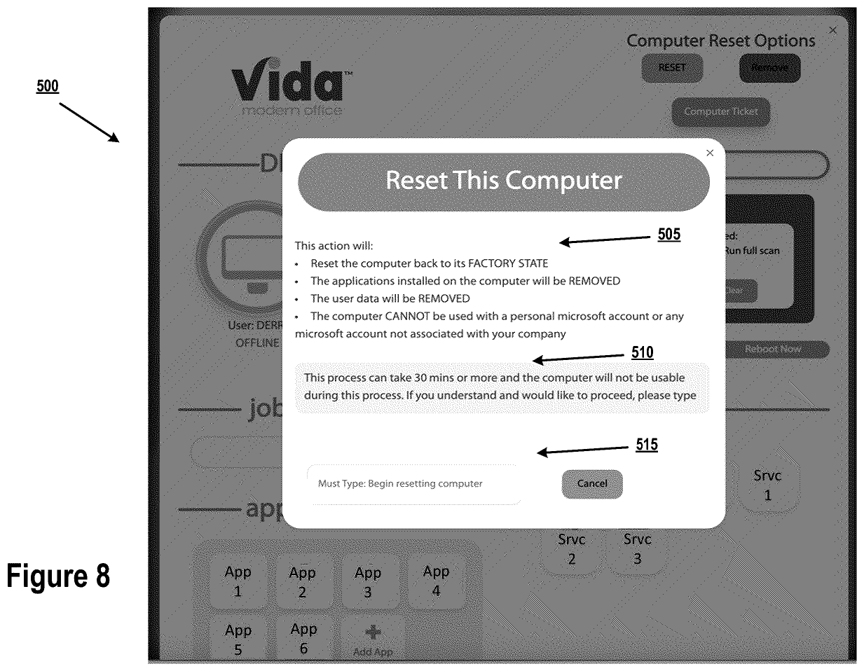

FIG. 8 depicts another alternative example of a user interface 500. Similarly to user interface 400, user interface 500 relates to resetting a computer by interacting with the “reset” option from the resolution options 215 of FIG. 5.

The user interface 500 may similarly include a results portion 505, a warning portion 510, and an action portion 515, which may be respectively similar to, and share one or more characteristics with, results portion 405, warning portion 410, and action portion 415. Description of portions 405/410/415 will not be repeated here for the sake of lack of redundancy.

Similarly to the various portions of FIG. 6, one or more of the portions in FIGS. 7 and 8 may be generated by AI/ML logic. Additionally, in some embodiments a storage may be queried prior to such generation to identify whether such user-parseable portions were previously generated and stored.

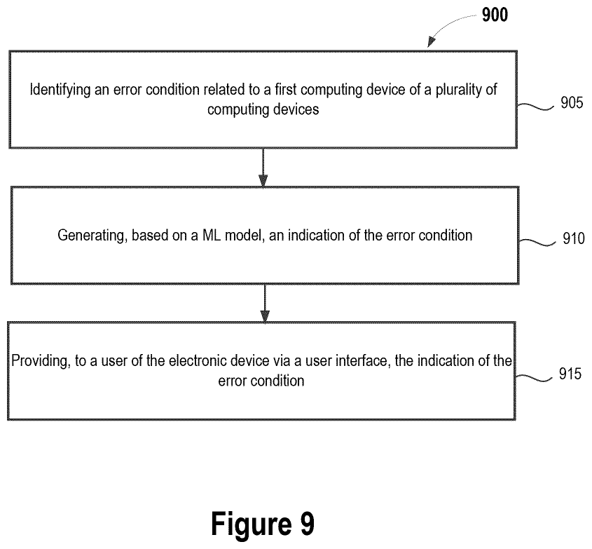

FIG. 9 illustrates an example process 900 related to AI-assisted IT management. The process 900 may be performed, for example, by the system 1000 (e.g., computing device).

The process 900 may include identifying, at 905, an error condition related to a first computing device of a plurality of computing devices. The process 900 may further include generating, at 910 based on a machine learning (ML) model, an indication of the error condition. In various embodiments, the indication may include one or both of a non-technical summary of the condition and a recommended action to remedy the error condition. The process 900 may further include providing, at 915 to a user of the electronic device via a user interface, the indication of the error condition.

It should be understood that the actions described in reference to FIG. 9 may not necessarily occur in the described sequence. For example, certain elements may occur in an order different than that described, concurrently with one another, etc. In some embodiments, the process 900 may include more or fewer elements than depicted or described.

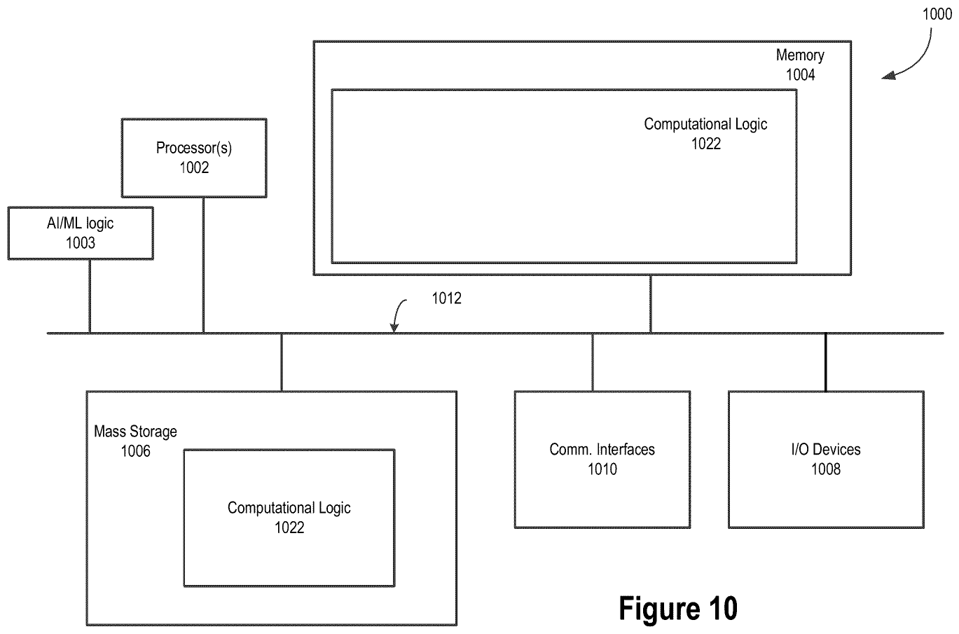

FIG. 10 illustrates an example computing device 1000 suitable for use to practice aspects of the present disclosure, in accordance with various embodiments. For example, the example computing device 1000 may be suitable to implement the functionalities, methods, techniques, or processes, in whole or in part, associated with FIGS. 1-9, and/or some other Figure herein.

As shown, computing device 1000 may include one or more processors 1002, each having one or more processor cores, and system memory 1004. The processor 1002 may include any type of unicore or multi-core processors. Each processor core may include a central processing unit (CPU), and one or more level of caches. The processor 1002 may be implemented as an integrated circuit. In some embodiments, the processor 1002 may include and/or implement AI/ML logic as previously described. In other embodiments, the AI/ML logic may be separate from, but communicatively coupled to, the processor as depicted by AI/ML logic 1003. As noted, in embodiments, the AI/ML logic 1003 may be implemented via hardware, software, firmware, and/or some combination thereof. The AI/ML logic 1003 may be an element of the example computing device 1000, or remote from but communicatively coupled with the computing device 1000.

The computing device 1000 may include mass storage devices 1006 (such as diskette, hard drive, volatile memory (e.g., dynamic random access memory (DRAM)), compact disc read only memory (CD-ROM), digital versatile disk (DVD) and so forth). In general, system memory 1004 and/or mass storage devices 1006 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth. The mass storage device(s) 1006 may be similar to, for example, one or more of the storage and/or database options described above.

The computing device 1000 may further include input/output (I/O) devices 1008 such as a display, keyboard, cursor control, remote control, gaming controller, image capture device, one or more three-dimensional cameras used to capture images, and so forth, and communication interfaces 1010 (such as network interface cards, modems, infrared receivers, radio receivers (e.g., Bluetooth), and so forth). I/O devices 1008 may be suitable for communicative connections with three-dimensional cameras or user devices. In some embodiments, I/O devices 1008 when used as user devices may include a device necessary for implementing the functionalities of receiving an image captured by a camera.

The communication interfaces 1010 may include communication chips (not shown) that may be configured to operate the device 1000 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 1010 may operate in accordance with other wireless protocols in other embodiments.

The above-described computing device 1000 elements may be coupled to each other via system bus 1012, which may represent one or more buses. In the case of multiple buses, they may be bridged by one or more bus bridges (not shown). Each of these elements may perform its conventional functions known in the art. In particular, system memory 1004 and mass storage devices 1006 may be employed to store a working copy and a permanent copy of the programming instructions implementing the operations, functionalities, techniques, methods, or processes, in whole or in part, associated with FIGS. 1-9, and/or some other Figure herein, generally shown as computational logic 1022. Computational logic 1022 may be implemented by assembler instructions supported by processor(s) 1002 or high-level languages that may be compiled into such instructions.

The permanent copy of the programming instructions may be placed into mass storage devices 1006 in the factory, or in the field, though, for example, a distribution medium (not shown), such as a compact disc (CD), or through communication interfaces 1010 (from a distribution server (not shown)).

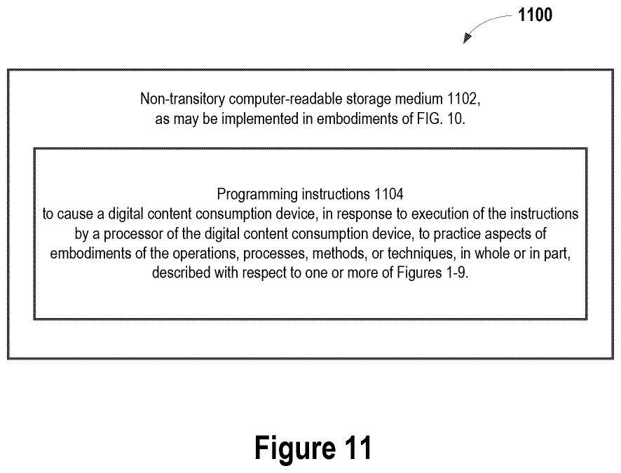

FIG. 11 illustrates an example non-transitory computer-readable storage media 1102 having instructions configured to practice all or selected ones of the operations associated with the processes described above. As illustrated, non-transitory computer-readable storage medium 1102 may include a number of programming instructions 1104. Programming instructions 1104 may be configured to enable a device, e.g., computing device 1000, in response to execution of the programming instructions, to perform one or more operations, processes, methods, or techniques, in whole or in part, described in reference to FIGS. 1-9, and/or some other Figure herein. In alternate embodiments, programming instructions 1104 may be disposed on multiple non-transitory computer-readable storage media 1102 instead. In still other embodiments, programming instructions 1104 may be encoded in transitory computer-readable signals.

In the preceding description, various aspects of the illustrative implementations were described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations were set forth in order to provide a thorough understanding of the illustrative implementations. It will be apparent to one skilled in the art that embodiments of the present disclosure may be practiced without the specific details. In other instances, well-known features have been omitted or simplified in order not to obscure the illustrative implementations.

In the preceding detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure.

Therefore, the detailed description is not to be taken in a limiting sense.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). More generally, various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The description may have used perspective-based descriptions such as top/bottom, in/out, over/under, and the like. Such descriptions were used to facilitate the discussion and were not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

These modifications may be made to the embodiments in light of the above detailed description. The terms used in the following claims should not be construed to limit the embodiments to the specific implementations disclosed in the specification and the claims.

Rather, the scope of the invention is to be determined entirely by the following claims, which are to be construed in accordance with established doctrines of claim interpretation.

### EXAMPLES

Example 1 includes one or more non-transitory computer-readable media (NTCRM) comprising instructions that, upon execution of the instructions by one or more processors of an electronic device, are to cause the electronic device to: identify an error condition related to a first computing device of a plurality of computing devices; generate, based on a machine learning (ML) model, an indication of the error condition, wherein the indication includes: a non-technical summary of the condition; and a recommended action to remedy the error condition; and provide, to a user of the electronic device via a user interface, the indication of the error condition.

Example 2 may include the subject matter of example 1, and/or some other example herein, wherein the recommended action is one of a plurality of pre-configured actions related to the error condition.

Example 3 may include the subject matter of any one or more of examples 1-2, and/or some other example herein, wherein the indication of the recommended action is generated based on AI/ML logic.

Example 4 may include the subject matter of any one or more of examples 1-3, and/or some other example herein, wherein the electronic device is separate from, and communicatively coupled with, the plurality of computing devices.

Example 5 may include the subject matter of any one or more of examples 1-4, and/or some other example herein, wherein the electronic device is the computing device.

Example 6 may include the subject matter of any one or more of examples 1-5, and/or some other example herein, wherein the error condition relates to presence of a virus on the computing device.

Example 7 may include the subject matter of any one or more of examples 1-6, and/or some other example herein, wherein the instructions are further to cause the electronic device to provide, to the user via the user interface, one or more interactive elements related to the recommended action.

Example 8 may include the subject matter of any one or more of examples 1-7, and/or some other example herein, wherein the instructions are further to cause the electronic device to: identify whether a previously-generated indication of the error condition is stored in an electronic database; and generate the indication of the error condition if the previously-generated indication of the error condition is not stored in the electronic database.

Example 9 may include the subject matter of example 8, and/or some other example herein, wherein the instructions are further to cause the electronic device to store the indication of the error condition in the electronic database.

Example 10 may include the subject matter of any one or more of examples 8-9, and/or some other example herein, wherein the instructions are further to cause the electronic device to: retrieve the previously-generated indication of the error condition if the previously-generated indication is stored in the electronic database; and provide the previously-generated indication of the error condition to the user via the user interface without generating the indication based on the ML model.

Example 11 may include an electronic device comprising: one or more processors; and one or more non-transitory computer-readable media (NTCRM) comprising instructions that, upon execution of the instructions by the one or more processors, are to cause the electronic device to: identify an error condition related to a first computing device of a plurality of computing devices; generate, based on a machine learning (ML) model, an indication of the error condition, wherein the indication includes: a non-technical summary of the condition; and a recommended action to remedy the error condition; and provide, to a user of the electronic device via a user interface, the indication of the error condition.

Example 12 may include the subject matter of example 11, and/or some other example herein, wherein the recommended action is one of a plurality of pre-configured actions related to the error condition.

Example 13 may include the subject matter of any one or more of examples 11-12, and/or some other example herein, wherein the indication of the recommended action is generated based on AI/ML logic.

Example 14 may include the subject matter of any one or more of examples 11-13, and/or some other example herein, wherein the instructions are further to cause the electronic device to provide, to the user via the user interface, one or more interactive elements related to the recommended action.

Example 15 may include the subject matter of any one or more of examples 11-14, and/or some other example herein, wherein the instructions are further to cause the electronic device to: identify whether a previously-generated indication of the error condition is stored in an electronic database; and generate the indication of the error condition if the previously-generated indication of the error condition is not stored in the electronic database.

Example 16 may include a method to be performed by an electronic device, wherein the method comprises: identifying an error condition related to a first computing device of a plurality of computing devices; generating, based on a machine learning (ML) model, an indication of the error condition, wherein the indication includes: a non-technical summary of the condition; and a recommended action to remedy the error condition; and providing, to a user of the electronic device via a user interface, the indication of the error condition.

Example 17 may include the subject matter of example 16, and/or some other example herein, wherein the recommended action is one of a plurality of pre-configured actions related to the error condition.

Example 18 may include the subject matter of any one or more of examples 16-17, and/or some other example herein, wherein the indication of the recommended action is generated based on AI/ML logic.

Example 19 may include the subject matter of any one or more of examples 16-18, and/or some other example herein, wherein the method further comprises providing, to the user via the user interface, one or more interactive elements related to the recommended action.

Example 20 may include the subject matter of any one or more of examples 16-19, and/or some other example herein, wherein the method further comprises: identifying whether a previously-generated indication of the error condition is stored in an electronic database; and generating the indication of the error condition if the previously-generated indication of the error condition is not stored in the electronic database.

Example Z01 may include an apparatus comprising means to perform one or more elements of a method, process, or technique described in or related to any of the examples herein, and/or any other method, process, or technique process described herein, or portions or parts thereof.

Example Z02 may include an apparatus comprising logic, modules, or circuitry to perform one or more elements of a method, process, or technique described in or related to any of the examples herein, and/or any other method, process, or technique described herein, or portions or parts thereof.

Example Z03 may include a method, technique, or process as described in or related to any of the examples herein, and/or any other method, process, or technique described herein, or portions or parts thereof.

Example Z04 may include a signal as described in or related to any of the examples herein, and/or any other method, process, or technique described herein, or portions or parts thereof.

Example Z05 may include an apparatus comprising one or more processors and non-transitory computer-readable media that include instructions which, when executed by the one or more processors, are to cause the apparatus to perform one or more elements of a method, process, or technique described in or related to any of the examples herein, and/or any other method, process, or technique described herein, or portions or parts thereof.

Example Z06 may include one or more non-transitory computer readable media comprising instructions that, upon execution of the instructions by one or more processors of an electronic device, are to cause the electronic device to perform one or more elements of a method, process, or technique described in or related to any of the examples herein, and/or any other method, process, or technique described herein, or portions or parts thereof.

Example Z07 may include a computer program related to one or more elements of a method, process, or technique described in or related to any of the examples herein, and/or any other method, process, or technique described herein, or portions or parts thereof.

1. One or more non-transitory computer-readable media (NTCRM) comprising instructions that, upon execution of the instructions by one or more processors of an electronic device, are to cause the electronic device to:
detect presence of an error condition at a first computing device of a plurality of computing devices;
generate, based on a machine learning (ML) model, a non-technical natural language alert related to the error condition, wherein the non-technical natural language alert includes:
a non-technical natural language summary of the error condition; and
a non-technical natural language indication of a recommended action to remedy the error condition; and
provide, to a user of the electronic device via a user interface, the non-technical natural language alert.

2. The one or more NTCRM of claim 1, wherein the recommended action is one of a plurality of pre-configured actions related to the error condition.

3. The one or more NTCRM of claim 1, wherein the indication of the recommended action is generated using the ML model.

4. The one or more NTCRM of claim 1, wherein the electronic device is separate from, and communicatively coupled with, the plurality of computing devices.

5. The one or more NTCRM of claim 1, wherein the electronic device is the first computing device.

6. The one or more NTCRM of claim 1, wherein the error condition relates to presence of a virus on the first computing device.

7. The one or more NTCRM of claim 1, wherein the instructions are further to cause the electronic device to provide, to the user via the user interface, one or more interactive elements related to the recommended action.

8. The one or more NTCRM of claim 1, wherein the instructions are further to cause the electronic device to:
identify whether a previously-generated non-technical natural language alert related to the error condition is stored in an electronic database; and
responsive to identification that the previously-generated non-technical natural language alert is not stored in the electronic database, generate the non-technical natural language alert.

9. The one or more NTCRM of claim 8, wherein the instructions are further to cause the electronic device to store the generated non-technical natural language alert in the electronic database.

10. The one or more NTCRM of claim 8, wherein the instructions are further to cause the electronic device to:
responsive to identification that the previously generated non-technical natural language alert is stored in the electronic database, retrieve the previously-generated non-technical natural language alert from the electronic database; and
provide the previously-generated non-technical natural language alert to the user via the user interface without generating a new non-technical natural language alert based on the ML model.

11. An electronic device comprising:
one or more processors; and
one or more non-transitory computer-readable media (NTCRM) comprising instructions that, upon execution of the instructions by the one or more processors, are to cause the electronic device to:
detect presence of an error condition at a first computing device of a plurality of computing devices;
generate, based on a machine learning (ML) model, a non-technical natural language alert related to the error condition, wherein the non-technical natural language alert includes:
a non-technical natural language summary of the error condition; and
a non-technical natural language indication of a recommended action to remedy the error condition; and
provide, to a user of the electronic device via a user interface, the non-technical natural language alert.

12. The electronic device of claim 11, wherein the recommended action is one of a plurality of pre-configured actions related to the error condition.

13. The electronic device of claim 11, wherein the indication of the recommended action is generated using the ML model-based.

14. The electronic device of claim 11, wherein the instructions are further to cause the electronic device to provide, to the user via the user interface, one or more interactive elements related to the recommended action.

15. The electronic device of claim 11, wherein the instructions are further to cause the electronic device to:
identify whether a previously-generated non-technical natural language alert related to the error condition is stored in an electronic database; and
responsive to identification that the previously-generated non-technical natural language alert is not stored in the electronic database, generate the non-technical natural language alert.

16. A method to be performed by an electronic device, wherein the method comprises:
detecting presence of an error condition at a first computing device of a plurality of computing devices;
generating, based on a machine learning (ML) model, a non-technical natural language alert related to the error condition, wherein the non-technical natural language alert includes:
a non-technical natural language summary of the error condition; and
a non-technical natural language indication of a recommended action to remedy the error condition; and
providing, to a user of the electronic device via a user interface, the non-technical natural language alert.

17. The method of claim 16, wherein the recommended action is one of a plurality of pre-configured actions related to the error condition.

18. The method of claim 16, wherein the indication of the recommended action is generated using the ML model.

19. The method of claim 16, wherein the method further comprises providing, to the user via the user interface, one or more interactive elements related to the recommended action.

20. The method of claim 16, wherein the method further comprises:
identifying whether a previously-generated non-technical natural language alert related to the error condition is stored in an electronic database; and
responsive to identification that the previously-generated non-technical natural language alert is not stored in the electronic database, generating the non-technical natural language alert.
